(19) United States
(12) Patent Application Publication
(10) Pub. No.: US 2006/0150586 A1
(43) Pub. Date: Jul. 13, 2006

(54) Equine eye protector

(76) Inventor: Ted Davidson, Comte Portneuf (CA)

Correspondence Address: Eric Fincham, 316 Knowlton Road, Lac Brome, QC, J0E 1V0, CA

(21) Appl. No.: 11/032,715

(22) Filed: Jan. 11, 2005

(51) Int. Cl. B68C 5/00

(52) U.S. Cl. 54/80.2

(57) ABSTRACT

A device for protecting the eyes of an animal such as a horse, the device comprising a band-designed to be secured on the head of the horse above the eyes, and a plurality of flexible spaced apart members hanging downwardly from the band for a distance sufficient to cover the eyes of the horse.

### FIELD OF THE INVENTION

The present invention relates to a device for protecting horses and more particularly, for protecting the eyes of a horse from flies and the like.

### BACKGROUND OF THE INVENTION

Masks to protect a horse's face and eyes are well known in the art. Generally, such devices have comprised various types of masks which are designed to completely cover the eyes of the horse. It is also known in the art to use insect repellent creams and ointments having a strength sufficient to be effective and which is applied directly to the animal or to the mask. However, this is undesirable as the repellant eventually gets into areas for which is it not intended such as in the eyes or mouth of the horse or rider.

Similarly, the use of various masks about the horse's eyes is sometimes problematic. Thus, some horses have protruding eyes which will touch most conventional masks rendering the same undesirable. Furthermore, it is frequently desirable to have easy access to the eyes for care and cleaning—the removal of the mask then becomes necessary.

### SUMMARY OF THE INVENTION

It is an object of the present invention to provide a device to protect the eyes of an animal such as a horse and which device is easily usable and permits access to the eyes of the horse.

According to one aspect of the present invention there is provided a device for protecting the eyes of an animal such as horses, the device comprising a band designed to be secured on the head of a horse above the eyes, and a plurality of flexible spaced apart members hanging downwardly from the band for a distance sufficient to cover the eyes of the horse.

The device of the present invention may either be incorporated with the traditional bridle of the horse or alternatively, a separate member could be utilized. It suffices to say that one skilled in the art could adapt the device to be utilized with other equipment carried by the horse.

Preferably the device is fabricated from leather although there are any number of synthetic materials from which it could be manufactured.

Preferably, the flexible spaced apart members or strands which hang downwardly from the band are at a length of between 20 and 50 cm and more preferably between 30 and 35 cm. In order to provide for vision, preferably the strands are separated from each other by a distance of between 2 and 10 mm and more preferably between 4 and 7 mm. Such an arrangement would provide between 24 to 40 such flexible members.

The device may form a portion of the conventional browband.

The flexible members, if desired, may have an element secured to the distal end thereof. Such an element could protect fraying at the edges and as well, add weight to the flexible members to keep them oriented in the proper direction. Thus, a bead like member of a desired material could be utilized.

The device of the present invention possesses several advantages over the prior art devices. Thus, the eyes of the horse are not completely covered and thereby the natural exposure to the air is permitted. Any movement of the horse's head will cause movement of the strands or members and be effective in causing any flies to move.

### BRIEF DESCRIPTION OF THE DRAWINGS

Having thus generally described the invention, reference will be made to the accompanying drawings illustrating an embodiment thereof, in which:

FIG. 1 is a perspective view of a device according to the present invention used in conjunction with a traditional bridle and with the head of the horse being shown in dotted lines;

FIG. 2 is a front elevational view of the device;

FIG. 3 is a top plan view thereof;

FIG. 4 is a cross sectional view of the device when placed in position; and

FIG. 5 is a perspective view of a slightly modified arrangement using the device of the present invention.

### DESCRIPTION OF THE PREFERRED EMBODIMENTS

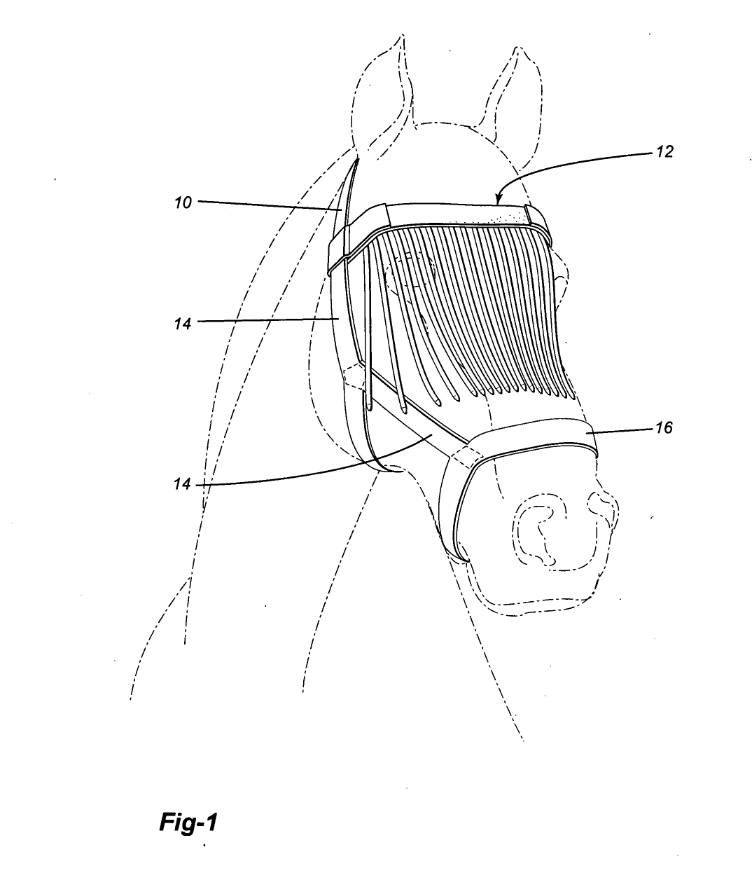

Referring to the drawings in greater detail and by reference characters thereto, there is illustrated in FIG. 1 a portion of a horse's bridle which includes a headstall 10, cheek straps 14, and a nose band 16.

Extending between cheek straps 14 there is conventionally a browband. In the illustrated embodiment, the browband is replaced by the device 12 of the present invention.

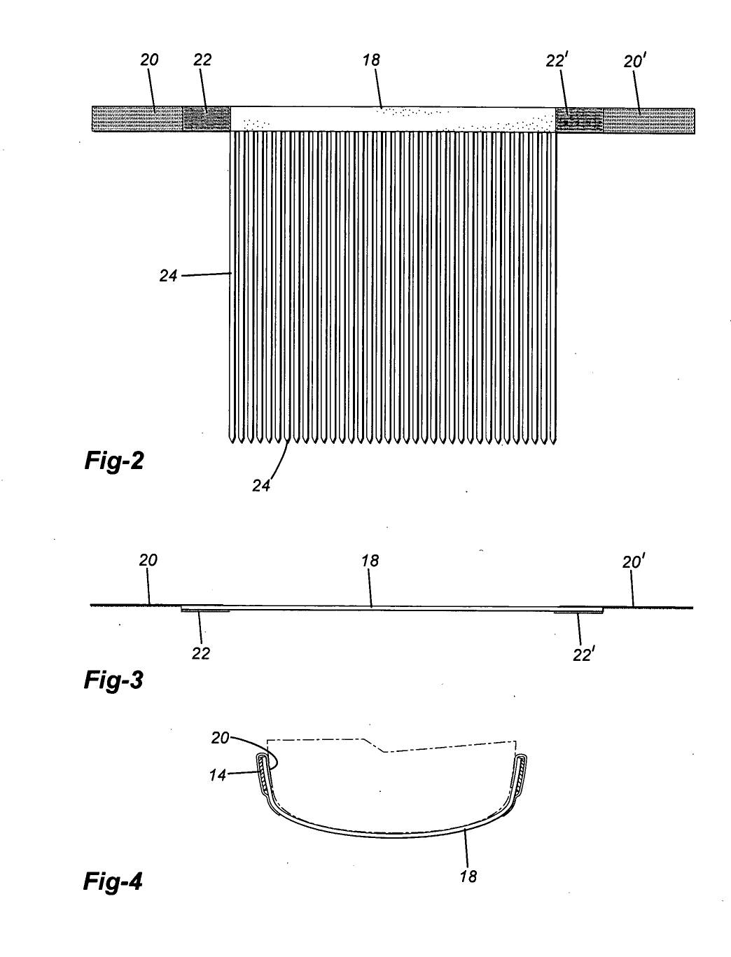

Device 12, as may be seen in FIGS. 2 to 4, includes a band 18 which is of a generally rectangular configuration. Band 18 has, at either end thereof, first loop sections 20, 20′ each of which have on one surface thereof the loops of a hook and loop attachment such as that marketed under the Trademark VELCRO. Interiorly of loop sections 20, 20′ are hook sections 22, 22′ respectively. Thus, as may be seen in FIG. 4, the band is secured about headstall 10 with sections 20 and 22 secured together and sections 20′, 22′ likewise secured together.

Extending downwardly from the central portion of band 18 are a plurality of flexible members or strands 24.

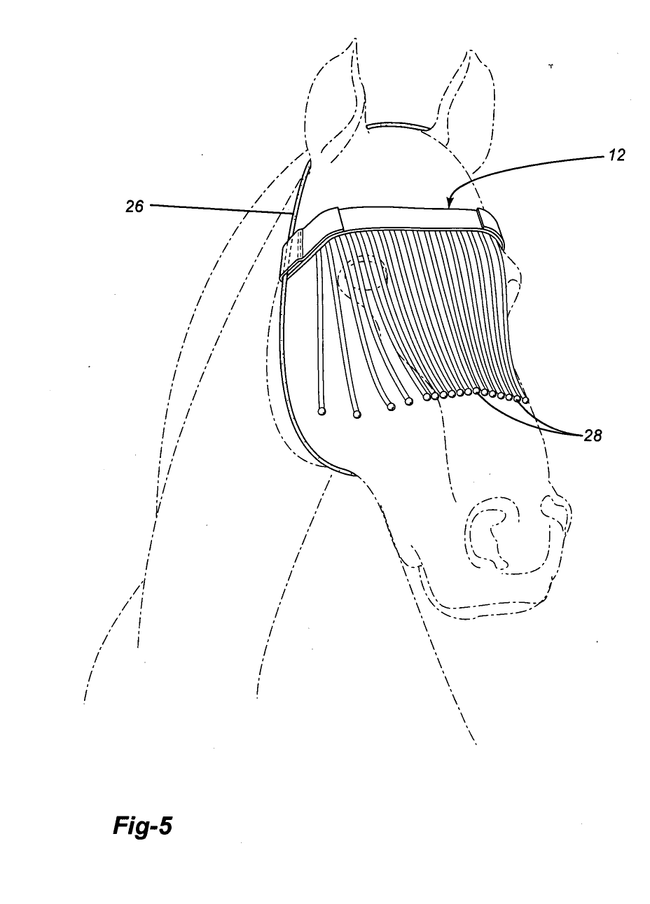

In the embodiment of FIG. 5, device 12 is shown secured about a modified type of headstall 26. As may be seen from this figure, the remaining portions of the bridle are not utilized. Beads 28 are secured to the distal end of each strand 24.

It will be understood that the above described embodiments are for purposes of illustration only that changes and modifications may be made thereto without departing from the spirit and scope of the invention.

I claim:

1. A device for protecting the eyes of an animal such as a horse, said device comprising:
a band designed to be secured on the head of a horse above the eyes;
a plurality of flexible spaced apart members hanging downwardly from said band for a distance sufficient to cover the eyes of the horse.

2. The device of claim 1 wherein said band and said members are formed of a leather material.

3. The device of claim 2 wherein said members have a length of between 30 and 35 cm.

4. The device of claim 3 wherein said members are spaced apart by a distance of between 4 and 7 mm.

5. The device of claim 4 wherein there are provided between about 24 to 40 flexible members.

6. The device of claim 1 wherein said device is fabricated of a synthetic material.

7. The device of claim 1 further including an element secured to a distal end of each of said flexible spaced apart members.

8. The device of claim 5 further including a hook and loop fastener at each end of said band.

9. In a bridle for a horse, the improvement comprising a device for protecting the eyes of the horse, said device comprising a band secured at either end thereof to the headstall, said band having a plurality of flexible spaced apart members hanging downwardly therefrom for a distance sufficient to cover the eyes of the horse.
